(19) United States
(12) Patent Application Publication
(10) Pub. No.: US 2006/0127745 A1
(43) Pub. Date: Jun. 15, 2006

(54) Electrode and fuel cell

(75) Inventors: Hidehiro Sasaki, Osaka (JP); Nobuyasu Suzuki, Nara-shi (JP); Yasunori Morinaga, Nara-shi (JP); Yuka Yamada, Nara-shi (JP); Tadashi Sotomura, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD., Osaka (JP)

(21) Appl. No.: 11/346,198

(22) Filed: Feb. 3, 2006

Related U.S. Application Data
(63) Continuation of application No. PCT/JP05/06644, filed on Apr. 5, 2005.

(30) Foreign Application Priority Data
Apr. 6, 2004 (JP) 2004-111800

(51) Int. Cl. H01M 4/86; H01M 4/96

(52) U.S. Cl. 429/42; 429/44

(57) ABSTRACT

The present invention provides an electrode comprising on an electrode substrate a catalytic layer comprising catalytically active particles and a solid polymer comprising a component represented by Structural Formula (1) below: 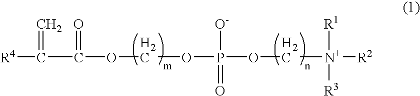
wherein R¹, R², R³, and R⁴ are the same or different, and independently represent a hydrogen atom or C₁₋₈ univalent hydrocarbon group, and m and n are independently an integer from 2 to 4; a fuel cell comprising the catalytic layer; and a fuel cell for bioimplantation whose surface is coated with the solid polymer.

### TECHNICAL FIELD

The present invention relates to an electrode and a fuel cell.

### BACKGROUND ART

Solid polymeric materials which incorporate ion-exchange groups such as sulfonic acid groups, carboxylic acid groups and the like in their polymer chains are known to be usable as solid polymer electrolytes. Such solid polymeric materials have properties of, for example, strongly bonding with specific ions and selectively letting cations or anions permeate therethrough. They are processed into particle, fiber, and film forms for use as electrode materials, solid polymer electrolytes for fuel cells, etc.

For example, Patent Publication 1 discloses the use of a heat-treated fluorocarbon sulfonamide cation-exchange membrane as a solid polymer electrolyte of a polymer electrolyte fuel cell. Polymer electrolyte fuel cells are fuel cells in which a polymer electrolyte membrane is disposed between a pair of electrodes (fuel electrode and air electrode). In polymer electrolyte fuel cells, a fuel gas containing hydrogen such as a reformed gas is supplied to the fuel electrode and an oxidizing gas containing oxygen such as air is supplied to the air electrode, and chemical energy generated upon oxidation of the fuel is directly converted into electrical energy.

In addition to that disclosed in Patent Publication 1, other solid polymer membranes for use in electrode materials and polymer electrolyte fuel cells are those formed from perfluorocarbon sulfonic acid-based polymers (i.e., Nafion™, manufactured by DuPont) as disclosed in, for example, Patent Publication 2.

Since such solid polymer membranes formed from perfluorocarbon sulfonic acid-based polymers exhibit enhanced proton conductivity once they have absorbed moisture, they are of use as electrode materials, solid polymer membranes for polymer electrolyte fuel cells, etc.

Patent Publication 1: Japanese Patent Publication No. 3444541

Patent Publication 2: U.S. Pat. No. 4,168,216

Patent Publication 3: Japanese Unexamined Patent Publication No. 2004-014232

Patent Publication 4: Japanese Unexamined Patent Publication No. 1987-195855

### DISCLOSURE OF THE INVENTION PROBLEM TO BE SOLVED BY THE INVENTION

Perfluorocarbon sulfonic acid-based polymers are strongly acidic. Therefore, when catalytically active particles are supported on such a polymer, they may be dissolved depending on the type of particle. Hence, the types of supportable particles are naturally limited to those that are highly acid resistant.

Moreover, due to their strong acidity, perfluorocarbon sulfonic acid-based polymers are poorly biocompatible. Recently, small fuel cells that use a sugar component or oxygen contained in blood as electrode active materials have been developed (for use as, for example, power sources for pacemakers). However, it is not advantageous to use such a fuel cell in the living body if it contains a strongly acidic solid polymer. Moreover, there is a problem of poisoning of the solid polymer surface due to the adsorption of oil/fat components.

The present invention was accomplished in view of the prior-art problems. A primary object of the present invention is to provide an electrode that can support a variety of catalytically active particles in a solid polymer, a fuel cell, and a highly biocompatible fuel cell for bioimplantation.

### MEANS FOR SOLVING THE PROBLEM

The inventors conducted extensive research to achieve the object described above and found as a result that the aforementioned object can be achieved when a specific solid polymer is used, and accomplished the present invention.

In particular, the present invention relates to the following electrodes and fuel cells.
1. An electrode comprising on an electrode substrate a catalytic layer comprising catalytically active particles and a solid polymer comprising a component represented by Structural Formula (1) below: 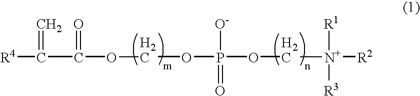
wherein R¹, R², R³, and R⁴ are the same or different, and independently represent a hydrogen atom or C₁₋₈ univalent hydrocarbon group; and m and n are independently an integer from 2 to 4.
2. The electrode according to Item 1, wherein the solid polymer contains the monomer in an amount of 60 to 100 wt. %.
3. The electrode according to Item 1, wherein the solid polymer is proton conductive.
4. The electrode according to Item 1, wherein the catalytically active particles are at least one member selected from the group consisting of activated carbons prepared by heat-treating acrylic fibers, binchotan, and activated carbons prepared by heat-treating beer yeast.
5. The electrode according to Item 1, wherein the solid polymer is represented by Structural Formula (2) below: 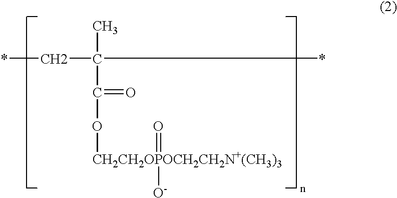
wherein n is an integer from 1000 to 5000000.
6. The electrode according to Item 1, wherein the electrode substrate is at least one member selected from the group consisting of metals, oxides and carbides.
7. The electrode according to Item 1 which is an oxygen-reducing electrode.
8. The electrode according to Item 1, wherein R⁴ is a hydrogen atom or methyl group; R¹, R², and R³ are the same or different, and independently represent a C₁₋₈ univalent hydrocarbon group; and m and n are independently an integer from 2 to 4.
9. The electrode according to Item 1, wherein R⁴ is a hydrogen atom or methyl group; R¹, R², and R³ are the same or different, and independently represent a C₁₋₄ univalent hydrocarbon group; and m an n are independently an integer from 2 to 4.
10. The electrode according to Item 1, wherein R¹, R², R³, and R⁴ are all methyl groups; and m and n are 2.
11. A fuel cell comprising a catalytic layer comprising catalytically active particles and a solid polymer comprising a component represented by Structural Formula (1) below: 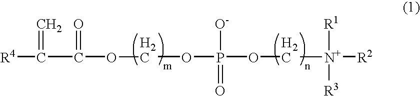
wherein R¹, R², R³, and R⁴ are the same or different, and independently represent a hydrogen atom or C₁₋₈ univalent hydrocarbon group; and m and n are independently an integer from 2 to 4.
12. A fuel cell for bioimplantation whose surface is coated with a solid polymer comprising a component represented by Structural Formula (1) below: 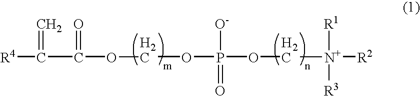
wherein R¹, R², R³, and R⁴ are the same or different, and independently represent a hydrogen atom or C₁₋₈ univalent hydrocarbon group; and m and n are independently an integer from 2 to 4.

### EFFECT OF THE INVENTION

The electrode and fuel cell of the present invention can support a variety of catalytically active particles since the solid polymer contained therein is chemically inactive. Moreover, the solid polymer has, in addition to superior proton conductivity, excellent resistance to oil/fat adsorption and oil/fat poisoning.

The fuel cell for bioimplantation of the present invention is highly biocompatible because the surface of the fuel cell is coated with the solid polymer having the aforementioned properties.

### BRIEF DESCRIPTION OF THE DRAWINGS

FIG. 1 is a graph showing the current-potential response of Test Electrodes C, D, E, and F measured in Example 1.

FIG. 2 is a graph showing the resistance to fat/oil adsorption of a solid polymer made from a dilute Lipidure solution measured in Test Example 1.

FIG. 3 is a graph showing the current-potential response of Test Electrodes A and B measured in Test Example 3.

### BEST MODE FOR CARRYING OUT THE INVENTION

The electrode and the fuel cell of the present invention are described below in detail.

1. Electrode

A feature of the electrode of the present invention is having on the electrode substrate a catalytic layer comprising catalytically active particles and a solid polymer using as a monomer a compound represented by Structural Formula (1) below: 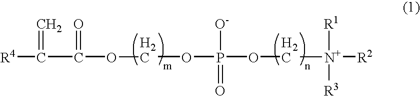
wherein R¹, R², R³, and R⁴ are the same or different, and independently represent a hydrogen atom or C₁₋₈ univalent hydrocarbon group; and m and n are independently an integer from 2 to 4.

In the monomer, R¹, R², R³, and R⁴ are the same or different, and independently represent a hydrogen atom or C₁₋₈ univalent hydrocarbon group; and m and n are independently an integer from 2 to 4.

Monomers are not limited insofar as they satisfy the conditions described above. Preferable are those in which R⁴ is a hydrogen atom or methyl group; R¹, R², and R³ are the same or different, and independently represent a C₁₋₈ univalent hydrocarbon group; and m and n are independently an integer from 2 to 4.

In particular, a monomer in which R¹, R², R³, and R⁴ are all methyl groups; and both m and n are 2 is especially preferable. This monomer can be called 2-methacryloyloxyethyl-2′-(trimethylammonio)ethylphosphate as well as 2-methacryloyloxyethyl phosphorylcholine (hereinafter sometimes referred to as “MPC”).

MPC is represented by Structural Formula (3) below.

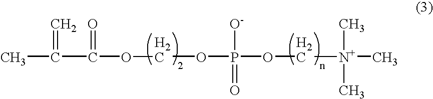

The solid polymer may be a homopolymer formed entirely from monomers represented by Structural Formula (1), or a copolymer formed from monomers represented by Structural Formula (1) and other monomers.

The proportion of monomer represented by Structural Formula (1) in the solid polymer is not limited. It is preferably about 60 to about 100 wt. %, more preferably about 70 to about 100 wt. %, and particularly preferably about 80 to about 100 wt. %.

Monomers that are copolymerizable with monomers represented by Structural Formula (1) include compounds bearing a double bond that can be addition-polymerized, for example, (1) ethylene, propylene, butene, isobutene, styrene, and like olefinic hydrocarbons, isomerized such olefins, oligomerized such olefins, olefinic compounds produced by introducing various derivatives into such olefins; (2) acrylic acid, methacrylic acid, vinylacetic acid, itaconic acid, crotonic acid, maleic acid, fumaric acid, and like ethylenically unsaturated carboxylic acids, oligomers of such carboxylic acids, anhydrides of such carboxylic acids, esters of such carboxylic acids formed with C₁₋₆ polyols, and ethylenic unsaturated carboxylic acid derivatives formed by introducing to such a carboxylic acid a carbonyl group, an amino group, a cyano group, a nitrile group or the like; (3) vinyl alcohols, esters formed from various carboxylic acids with vinyl alcohols, ethers formed from vinyl alcohols with various other alcohols, vinyl alcohol derivatives formed by introducing to a vinyl alcohol a carbonyl group, an amino group, a cyano group, a nitrile group or the like; etc.

The molecular weight of the solid polymer is preferably about 10000 to about 10000000, and more preferably about 50000 to 5000000.

Commercially available products are usable as the solid polymer. For example, an MPC-homopolymerized solid polymer is commercially available under the trademark of “Lipidure-HM-500” (molecular weight: about 80000, manufactured by NOF Corporation, 5% aqueous solution. This solid polymer can be represented by Structural Formula (2):

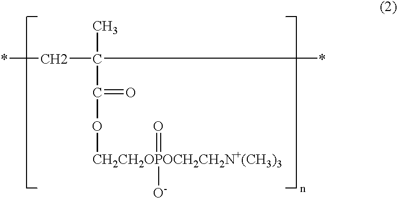

In the formula given above, n is in a range that satisfies a molecular weight of about 80000 in the case of the aforementioned commercial product. However, when such a solid polymer is produced by homopolymerizing MPC, n can be in a broad range of preferably about 1000 to about 5000000, and more preferably about 10000 to about 500000.

When the solid polymer is produced by polymerizing monomer(s), a monomer represented by Structural Formula (1) (in combination with other copolymerizable monomer(s) if necessary) is subjected to radical polymerization.

For example, when MPC is homopolymerized, it can be radically polymerized by solution polymerization, bulk polymerization, emulsion polymerization, suspension polymerization, etc. Polymerization conditions (e.g., temperature and time) are not limited insofar as the desired polymerization proceeds. Typically, the polymerization temperature is about 0 to about 100° C., and the polymerization time is about 10 minutes to about 48 hours. The polymerization atmosphere is preferably of nitrogen, helium, or like inert gas.

Known radical polymerization initiators can be used, such as benzoyl peroxide, t-butylperoxy-2-ethylhexanoate, succinyl peroxide, glutar peroxide, succinyl peroxyglutarate, di-2-ethoxyethyl peroxycarbonate, 2-hydroxy-1,1-dimethylbutyl peroxypivalate, and like organic peroxides; azobisisobutyronitrile, dimethyl-2,2′-azobisisobutyrate, 1-((1-cyano-1-methylethyl)azo)formamide, 2,2′-azobis(2-methyl-N-(2-hydroxyethyl)propionamide), 2,2′-azobis(2-methylpropionamide) dihydrate, 4,4′-azobis(2-(hydroxymethyl)propionitrile), and like azo compounds; persulfates; persulfate-hydrogensulfite-based compounds; etc. Such polymerization initiators can be used singly or as a combination of two or more kinds. The amount of polymerization initiator is preferably about 0.01 to about 5 parts by weight per 100 parts by weight of monomer.

In order to shape the solid polymer, an aqueous or alcoholic solution or dispersion of the polymer produced according to an aforementioned polymerization method is introduced into a flat mold, disk mold, or the like. Heat drying, reduced-pressure drying, or the like can be performed in combination as necessary.

The solid polymer is preferably proton conductive. When proton conductive, the solid polymer is advantageous for use as a component of an oxygen-reducing electrode. For example, a solid polymer solely composed of an MPC polymer (solid polymer represented by Structural Formula (2) presented above) is a good proton conductor.

The electrode of the present invention has on its electrode substrate a catalytic layer containing the solid polymer and catalytically active particles.

Catalytically active particles are not limited. Examples are particles of activated carbons prepared by heat-treating acrylic fibers, binchotan (activated carbons; charcoal products obtained using hard broadleaf timbers such as kashi oak, nara oak, and the like, as known as “binchotan” in Japan.), activated carbons prepared by heat-treating beer yeast, etc. Such particles have the ability to function as oxygen reduction catalysts. In addition to activated carbons, particles of manganese dioxide, which are likely to be dissolved under strongly acidic conditions, are usable as particles having an ability to function as an oxygen-reduction catalyst. An electrode that is furnished with a catalytic layer containing particles that can function as an oxygen-reduction catalyst is of use as, for example, an oxygen-reducing electrode.

The mean particle diameter of catalytically active particles is not limited, but it is preferably about 0.01 to about 100 μm.

The amount of catalytically active particles supported on the solid polymer is not limited, but it is preferably 30 wt. % or greater, and more preferably about 30 to about 50 wt. %, on a dry basis.

Known electrode substrates are usable herein. For example, metals, oxides, carbides, and the like fabricated into a plate form are usable as electrode substrates.

Methods for creating a catalytic layer on the electrode substrate are not limited. For example, a catalytic layer can be created by dissolving the solid polymer in a suitable solvent, adding/mixing the catalytically active particles, applying the resulting suspension to an electrode substrate, and drying it.

Solvents for dissolving the solid polymer are not limited. For example, water, alcohols (in particular, ethanol), etc., are usable. Solvents include homosolvents and mixed solvents.

The content of the polymer in the solution (solution not containing the catalytically active particles) is not limited, but it is preferably in the range of 0.01 to 30 wt. %. With contents less than 0.01 wt. %, the amount of polymer is too little, and the desired effects may not be attained. Contents exceeding 30 wt. % are not preferable because the workability with respect to coating is impaired due to increased solution viscosity, and the resulting film lacks uniformity.

The suspension (containing the catalytically active particles) of the solid polymer can be applied to the electrode substrate according to, for example, a dipping method, a spray method, a roller coating method, a spin coating method, etc. The application thickness is not limited, but it is preferably about 0.5 to about 10 μm.

The electrode of the present invention containing the solid polymer described above as a constituent possesses excellent resistance to oil/fat adsorption and oil/fat poisoning, and other superior properties.

2. Fuel Cell

The fuel cell of the present invention comprises a catalytic layer containing catalytically active particles and a solid polymer comprising as a component a monomer represented by Structural Formula (1) presented above. Description of the solid polymer is as given above in respect of the aforementioned electrode. An MPC homopolymer represented by Structural Formula (2) is preferable as the solid polymer.

For a polymer electrolyte fuel cell, such a catalytic layer may for example be disposed between a solid electrolyte and a fuel electrode (as a catalyst for a fuel electrode) or between a solid electrolyte and an air electrode (as a catalyst for an air electrode), or at both locations. The catalytically active particles can be selected from various particles, including the aforementioned activated carbon (charcoal) particles, manganese dioxide particles, etc., according to the desired catalytic ability (ability to function as a catalyst for a fuel electrode or an air electrode, or like ability).

Methods and conditions for forming a catalytic layer on electrodes (fuel and air electrodes in the case of the aforementioned fuel cell) are as described above.

A fuel cell whose surface is coated with a solid polymer comprising as a component a monomer represented by Structural Formula (1) is encompassed by the fuel cell of the present invention.

When the surface of a small fuel cell that uses a sugar component or oxygen in blood as an electrode active material is coated with the aforementioned solid polymer, such a fuel cell is usable as a fuel cell for bioimplantation. Such a fuel cell for bioimplantation can be used as, for example, a power source for a pacemaker.

Since the aforementioned solid polymer is chemically inactive and has excellent resistance to oil/fat adsorption and oil/fat poisoning and like characteristics, the fuel cell for bioimplantation of the present invention is highly biocompatible.

The amount of the solid polymer in coating the surface of the fuel cell is not limited, and it can be suitably determined according to the type of solid polymer, the size of the fuel cell, and other factors.

### EXAMPLES

An Example and Test Examples are given below to illustrate the invention in more detail.

### Example 1

(Preparation of Electrodes)

Test Electrodes C, D, and E were prepared in Example 1. Preparation procedure is described below.

Glassy carbon (diameter: 3 mm) was used as an electrode substrate.

The following catalytically active particles were used.

TABLE 1

| | Test Electrode C | Test Electrode D | Test Electrode E |
|---|---|---|---|
| Catalytically | Activated carbon | Binchotan | Activated carbon |
| active particles | prepared by | (charcoal product) | prepared by |
| | heat-treating | | heat-treating |
| | acrylic fibers | | beer yeast |

All the catalytically active particles were products of Cooperative Association Latest, and were used after grinding to 160 to 200 mesh.

“Lipidure™-HM-500” (manufactured by NOF Corporation, 5% solution) was used as a solid polymer source. This solution was diluted to have a polymer content of 0.05 wt. % (hereinafter referred to as “dilute Lipidure solution”).

The structure of the solid polymer (molecular weight: about 80000) formed from the dilute Lipidure solution is as follows:

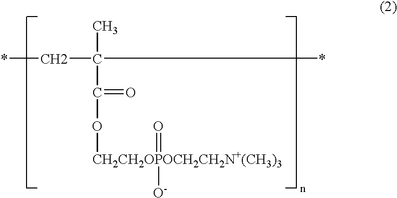

3 mg of catalytically active particles and 200 μl of the dilute Lipidure solution were mixed in a 1.5 ml-disposable microchip, and then stirred using a homogenizer, thereby giving a suspension.

7 μl of the suspension was sampled and applied to the surface of glassy carbon and dried. Application and drying were performed 3 times.

The procedure described above was carried out for each type of catalytically active particle to prepare Test Electrodes C, D and E.

(Oxygen-Reducing Properties of the Electrodes)

The oxygen-reducing properties of each electrode were evaluated in reference to a cyclic voltammogram obtained by cyclic voltammetry using a three-electrode cell in which a test electrode was used as a working electrode, a platinum winding was used as an auxiliary electrode, a silver/silver chloride electrode prepared with saturated potassium chloride was used as a reference electrode, and a 0.1 M sodium hydroxide solution having a saturated dissolved oxygen content by contacting with pure oxygen gas for 30 minutes was used as an electrolyte.

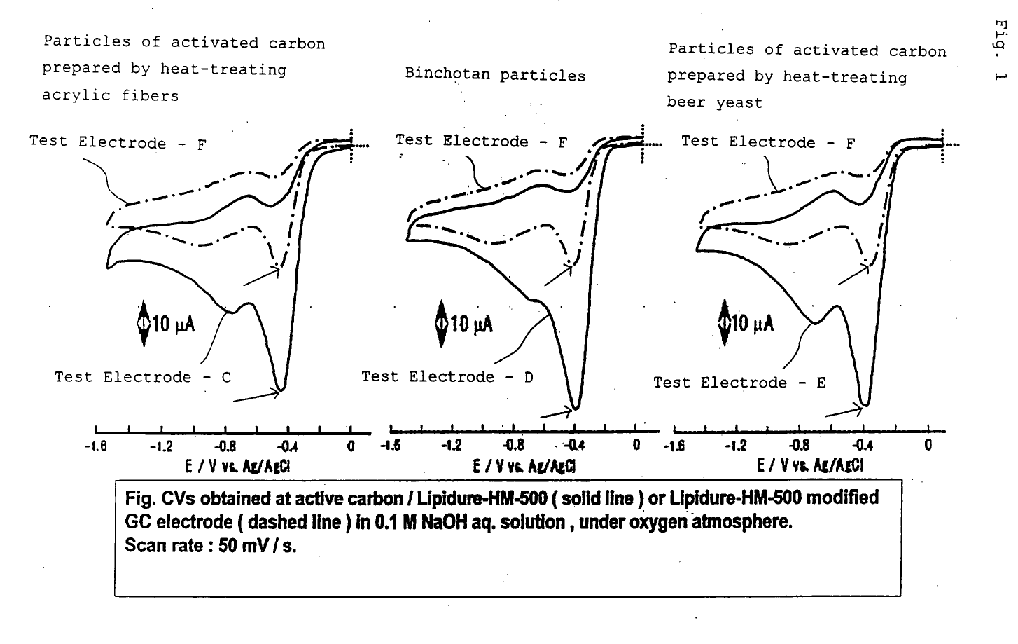

In particular, the potential of the working electrode relative to the reference electrode was swept at a rate of 100 mV/s in the negative direction from the spontaneous potential. Upon reaching −1.5 V, the potential was swept back at a rate of 100 mV/s in the direction of the spontaneous potential. During the potential sweep, the electrolytic current flowing between the test electrode (working electrode) and the auxiliary electrode was recorded in relation to the potential of the reference electrode. The results are shown in FIG. 1.

The oxygen-reducing properties of Test Electrode F that does not contain catalytically active particles is also presented in FIG. 1 for reference. Test Electrode F was prepared in the same manner as described in Example 1 except that no catalytically active particles were used.

As can be understood from FIG. 1, the peak oxygen reduction potentials of Test Electrodes C, D and E appear at potentials similar to the peak oxygen reduction potential of Test Electrode F, and the peak oxygen reduction current densities of Test Electrodes C, D and E are significantly greater than that of Test Electrode F.

In particular, the peak oxygen reduction current of Test Electrode F (dotted line) was 25 μA while that of Test Electrode C was 51 μA, that of Test Electrode D was 56 μA, and that of Test Electrode E was 55 μA, indicating that the peak oxygen reduction currents of the electrodes of the present invention were all greater than 50 μA.

These results demonstrate that in the electrode of the present invention the solid polymer does not hamper the ability of the catalytically active particles to function as an oxygen reduction catalyst.

Additionally, Test Electrode G was prepared in the same manner as in Example 1 except that powdered manganese dioxide (manganese dioxide powder manufactured by Kojundo Chemical Laboratory Co., Ltd., ground to 160 to 200 mesh) was used as the catalytically active particles. An evaluation of oxygen-reducing property as described above was carried out with respect to this electrode.

A cyclic voltammogram (not shown) demonstrated that the peak oxygen reduction potential of Test Electrode G appears at a potential similar to the peak oxygen reduction potential of Test Electrode F, and the peak oxygen reduction current density of Test Electrode G is significantly greater than that of Test Electrode F.

This result establishes that in the electrode of the present invention the solid polymer does not hamper the ability of the catalytically active particles to function as an oxygen reduction catalyst not only when the catalytically active particles are of activated carbon but also when of manganese dioxide.

### Test Example 1

### Fat/Oil Resistance of Solid Polymer

The oil/fat resistance of a solid polymer membrane formed from the solid-polymer source used in Example 1 (dilute Lipidure solution) was investigated.

This test used the quartz crystal microbalance method (QCM method).

A gold electrode having a diameter of 13 mm was vapor-deposited on the surface of a quartz crystal oscillator having a diameter of 25.4 mm. After the portion surrounding the gold electrode was covered with a masking tape, the dilute Lipidure solution was applied to the gold electrode in an amount of 70.2 μl/cm² according to a dipping method.

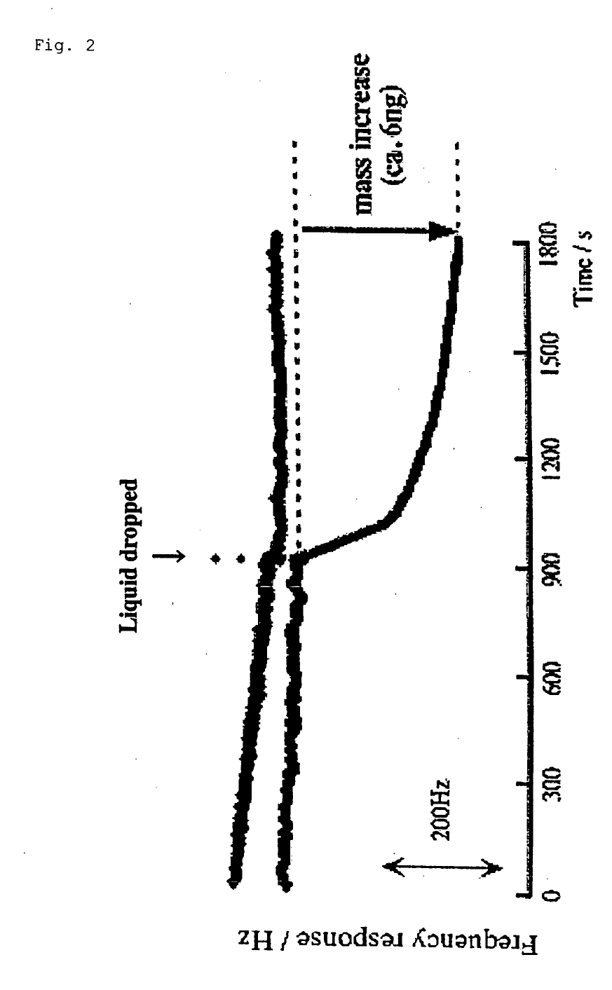

20 ml of a pH 7.4 phosphoric acid buffer solution was used as an electrolyte. The aforementioned quartz crystal oscillator was oscillated in the electrolyte at a frequency of 6 MHz (initial value). Decrease of oscillation frequency was ascertained over 3000 seconds. 900 seconds after the beginning of oscillation, 50 μl of 0.5 wt. % ethyl oleate was added dropwise. FIG. 2 shows the time (horizontal axis)-oscillation frequency (vertical axis) relationship. FIG. 2 also shows the result for a quartz crystal oscillator which did not have a coating of the solid polymer.

In FIG. 2, the upper line indicates the quartz crystal oscillator furnished with a coating of the solid polymer, and the lower line indicates the quartz crystal oscillator not furnished with a coating of the solid polymer.

The oscillation frequency of the quartz crystal oscillator without a coating of the solid polymer sharply decreased when ethyl oleate was added, and came to a constant rate about 1800 seconds after the beginning of oscillation. The decrease in oscillation frequency was presumably caused by the increase of the weight of the quartz crystal oscillator due to the adsorption of ethyl oleate (oil/fat) onto the gold electrode.

In contrast, the quartz crystal oscillator having a coating of the solid polymer did not show a noteworthy decrease in oscillation frequency by the addition of ethyl oleate. This result demonstrates that the solid polymer membrane formed from the dilute Lipidure solution has good oil/fat resistance.

### Test Example 2

### Poisoning Resistance of Solid Polymer

7 μl of the dilute Lipidure solution was sampled, and applied to the surface of glassy carbon (diameter: 6 mm) and then dried. Application and drying were repeated 3 times, thereby giving Test Electrode A.

“Nafion™-117” (manufactured by Wako Pure Chemical Industries, Ltd.) was used as another solid polymer source. This solid polymer source was diluted with ethanol to have a polymer content of 0.05 wt. % (hereinafter referred to as “dilute Nafion solution”).

7 μl of the dilute Nafion solution was sampled, and applied to the surface of glassy carbon (diameter: 6 mm) and then dried. Application and drying were repeated 3 times, thereby giving Test Electrode B.

The oxygen-reducing properties of each electrode were evaluated in reference to a cyclic voltammogram obtained by cyclic voltammetry using a three-electrode cell in which Test Electrode A or B was used as a working electrode, a platinum winding was used as an auxiliary electrode, and a silver/silver chloride electrode prepared with saturated potassium chloride was use as a reference electrode. An electrolyte prepared by adding 50 μl of 0.5 wt. % ethyl oleate to 20 ml of a pH 7.4 phosphoric acid buffer solution was used.

Potential sweeps were performed 5 times a day for 10 days in the same manner as in Example 1.

When Test Electrode A was used, the results of every oxygen-reducing property measurement were similar to those obtained at the initial stage of the experiment. In contrast, when Test Electrode B was used, the peak oxygen reduction current showed a gradual decrease.

These results establish that the electrode surface area effective for oxygen reduction of the solid polymer membrane formed from the dilute Nafion solution diminishes due to ethyl oleate poisoning, while in contrast, the solid polymer membrane formed from the dilute Lipidure solution, shows good resistance to ethyl oleate poisoning.

### Test Example 3

### Proton Conductivity of Solid Polymer

The oxygen-reducing properties of Test Electrodes A and B prepared in Test Example 2 were examined.

The oxygen-reducing properties of each electrode were evaluated in reference to a cyclic voltammogram obtained by cyclic voltammetry using a three-electrode cell in which a test electrode was used as a working electrode, a platinum winding was used as an auxiliary electrode, a silver/silver chloride electrode prepared with saturated potassium chloride was used as a reference electrode, and a 0.1 M sodium hydroxide solution having a saturated dissolved oxygen content by contacting with pure oxygen gas for 30 minutes was used as an electrolyte.

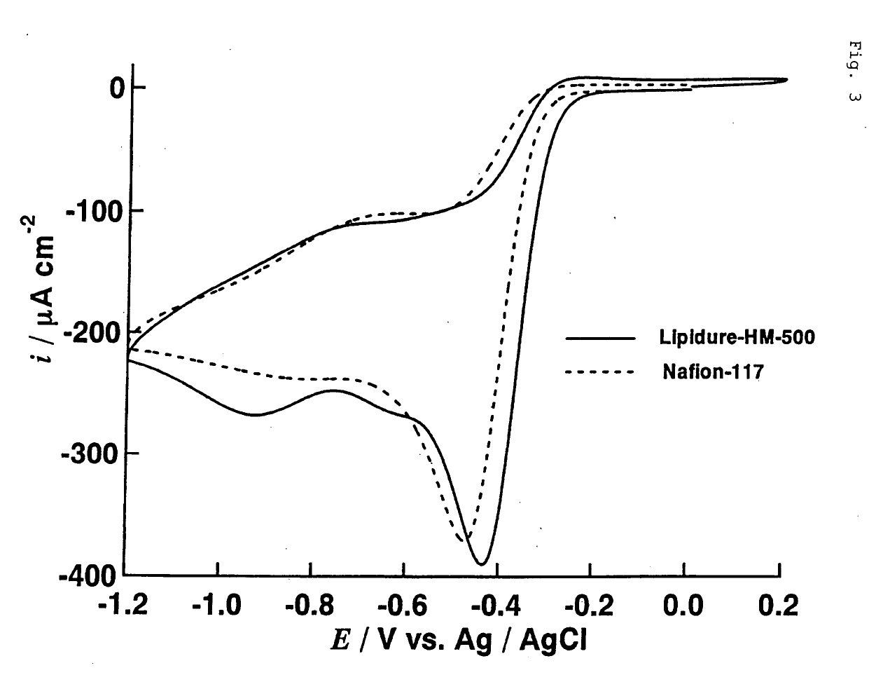

In particular, the potential of the working electrode relative to the reference electrode was swept at a rate of 100 mV/s in the negative direction from the spontaneous potential. Upon reaching −1.2 V, the potential was swept back at a rate of 100 mV/s in the direction of spontaneous potential. During the potential sweep, the electrolytic current flowing between the test electrode (working electrode) and the auxiliary electrode was recorded in relation to the potential of the reference electrode. The results are shown in FIG. 3. In FIG. 3, the solid line indicates the results for Test Electrode A and the dotted line indicates the results for Test Electrode B.

FIG. 3 shows that the peak oxygen reduction potential of Test Electrode A was similar to or somewhat to the positive side relative to the peak oxygen reduction potential of Test Electrode B. Moreover, the peak oxygen reduction current density of Test Electrodes A was similar to or a little greater than the peak oxygen reduction current density of Test Electrode B. These results demonstrate that the solid polymer formed from the dilute Lipidure solution has a proton conductivity similar to or greater than that of the solid polymer formed from the dilute Nafion solution.

### INDUSTRIAL APPLICABILITY

The electrode and fuel cell of the present invention can support a variety of catalytically active particles since the solid polymer contained therein is chemically inactive. Moreover, the solid polymer exhibits excellent resistance to oil/fat adsorption and oil/fat poisoning in addition to superior proton conductivity.

The fuel cell for bioimplantation of the present invention is highly biocompatible because the surface of the fuel cell is coated with the solid polymer having the aforementioned properties.

1. An electrode comprising on an electrode substrate a catalytic layer comprising catalytically active particles and a solid polymer comprising a component represented by Structural Formula (1) below: 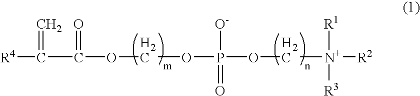
wherein R¹, R², R³, and R⁴ are the same or different, and independently represent a hydrogen atom or C₁₋₈ univalent hydrocarbon group; and m and n are independently an integer from 2 to 4.

2. The electrode according to claim 1, wherein the solid polymer contains the monomer in an amount of 60 to 100 wt. %.

3. The electrode according to claim 1, wherein the solid polymer is proton conductive.

4. The electrode according to claim 1, wherein the catalytically active particles are at least one member selected from the group consisting of activated carbons prepared by heat-treating acrylic fibers, binchotan, and activated carbons prepared by heat-treating beer yeast.

5. The electrode according to claim 1, wherein the solid polymer is represented by Structural Formula (2) below: 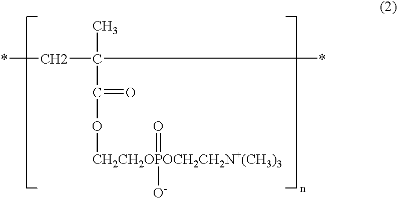
wherein n is an integer from 1000 to 5000000.

6. The electrode according to claim 1, wherein the electrode substrate is at least one member selected from the group consisting of metals, oxides and carbides.

7. The electrode according to claim 1 which is an oxygen-reducing electrode.

8. The electrode according to claim 1, wherein R⁴ is a hydrogen atom or methyl group; R¹, R², and R³ are the same or different, and independently represent a C₁₋₈ univalent hydrocarbon group; and m and n are independently an integer from 2 to 4.

9. The electrode according to claim 1, wherein R⁴ is a hydrogen atom or methyl group; R¹, R², and R³ are the same or different, and independently represent a C₁₋₄ univalent hydrocarbon group; and m an n are independently an integer from 2 to 4.

10. The electrode according to claim 1, wherein R¹, R², R³, and R⁴ are all methyl groups; and m and n are 2.

11. A fuel cell comprising a catalytic layer comprising catalytically active particles and a solid polymer comprising a component represented by Structural Formula (1) below: 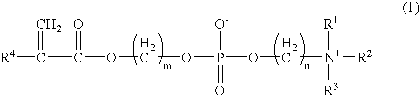
wherein R¹, R², R³, and R⁴ are the same or different, and independently represent a hydrogen atom or C₁₋₈ univalent hydrocarbon group; and m and n are independently an integer from 2 to 4.

12. A fuel cell for bioimplantation whose surface is coated with a solid polymer comprising a component represented by Structural Formula (1) below: 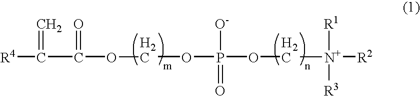
wherein R¹, R², R³, and R⁴ are the same or different, and independently represent a hydrogen atom or C₁₋₈ univalent hydrocarbon group; and m and n are independently an integer from 2 to 4.
